(19) United States
(12) Patent Application Publication
(10) Pub. No.: US 2012/0265364 A1
(43) Pub. Date: Oct. 18, 2012

(54) NETWORK BASED COFFEE ROASTING MANAGEMENT

(76) Inventor: Brian Zambrano, Alameda, CA (US)

(21) Appl. No.: 13/447,252

(22) Filed: Apr. 15, 2012

Related U.S. Application Data
(60) Provisional application No. 61/475,798, filed on Apr. 15, 2011.

(51) Int. Cl. G05D 23/00

(52) U.S. Cl. 700/300

(57) ABSTRACT

The present technology automatically manages data associated with coffee bean roasting, reports data, helps track inventory of the data, and provides a mechanism for sharing the data with other users. The data may include coffee bean data, coffee bean roast data, cupping data for a roast, inventory data, predictions or suggestions for coffee bean or coffee bean roast data, and blends of coffee beans for roasting. The service allows a user to create an account with the roast management service, allow the service to manage the data, have reports and other information provided by the service, and manage personal account information with the service. Different types of coffee data can be uploaded to a network service, for example from a client roast logging application in communication with the roast management service.

### REFERENCE TO RELATED APPLICATIONS

The present application claims the priority benefit of provisional patent application No. 61/475,798, filed Apr. 15, 2011, entitled “Network Based Coffee Roasting Management”, the entire disclosure of which is incorporated herein by reference.

### BACKGROUND

Coffee is a beverage that has been enjoyed by people for many years. Typically, coffee is prepared by roasting coffee beans and brewing the beans with water. The roasting process transforms chemical and physical properties of green coffee beans into roasted coffee beans. When roasted, coffee beans may undergo a change in color, smell, density, and perhaps most importantly taste. The details regarding how a coffee bean is roasted affects the character and taste of the resulting brewed coffee.

Coffee beans are commonly roasted by large commercial suppliers and sold in super markets or other retail locations. Smaller entities, such as specialty coffee shops and at-home brewers, also roast coffee beans. These smaller entities may manually track their roasts to maintain a fine degree of control over their coffee bean roasting and brewed coffee.

What is needed is a system for managing and sharing coffee roasting data among entities that roast their own coffee beans.

### SUMMARY OF THE INVENTION

The present technology automatically manages data associated with coffee bean roasting, reports data, helps track inventory of the data, and provides a mechanism for sharing the data with other users. The data may include coffee bean data, coffee bean roast data, cupping data for a roast, inventory data, predictions or suggestions for coffee bean or coffee bean roast data, and blends of coffee beans for roasting. The service allows a user to create an account with the roast management service, allow the service to manage the data, have reports and other information provided by the service, and manage personal account information with the service. Different types of coffee data can be uploaded to a network service, for example from a client roast logging application in communication with the roast management service.

A coffee bean roasting service may receive coffee bean data and coffee bean roast data. The coffee bean roast data can be received from a remote client device. The coffee bean roast data and the coffee bean data can be associated with a user account with a roast management service. The coffee bean roast data and the coffee bean data can be reported by a server through an interface provided over a network.

Roast data can be stored by receiving a series of temperature data points by a computing device. The temperature data points may be associated with a roast of one or more coffee beans. The temperature data points and timestamps can be associated with each temperature data point by the computing device. The temperature data points and timestamps can be transmitted to a remote network application, the temperature data points and timestamps to be stored in association with a roast management account associated with a user.

### BRIEF DESCRIPTION OF THE DRAWINGS

FIG. 1 is a block diagram of an exemplary system for managing coffee bean roast data.

FIG. 2 is a block diagram of an exemplary roast management application.

FIG. 3 is a flow chart of an exemplary method for logging roast data.

FIG. 4 is a flow chart of an exemplary method for managing roast data.

FIG. 5 is a flow chart of an exemplary method for receiving bean and roast data

FIG. 6 is a flow chart of an exemplary method for managing bean inventory.

FIG. 7 is a flow chart of an exemplary method for processing roast requests.

FIG. 8 is a flow chart of an exemplary method for generating a report

FIG. 9 is a flow chart of an exemplary method for generating a roast prediction

FIG. 10 is a flow chart of an exemplary method for accessing shared roast data.

FIG. 11 is an exemplary interface for managing roast logging.

FIG. 12 is an exemplary interface for managing coffee bean roast data.

FIG. 13 is an exemplary interface for managing cupping data.

FIG. 14 is an exemplary interface for managing coffee bean roast data.

FIG. 15 is an exemplary interface for managing a user roast profile.

FIG. 16 illustrates an exemplary computing system 1600 that may be used to implement an embodiment of the present technology.

### DETAILED DESCRIPTION

The present technology automatically manages data associated with coffee bean roasting, reports data, helps track inventory of the data, and provides a mechanism for sharing the data with other users. The data may include coffee bean data, coffee bean roast data, cupping data for a roast, inventory data, predictions or suggestions for coffee bean or coffee bean roast data, and blends of coffee beans for roasting. The service allows a user to create an account with the roast management service, allow the service to manage the data, have reports and other information provided by the service, and manage personal account information with the service. Different types of coffee data can be uploaded to a network service, for example from a client roast logging application in communication with the roast management service.

A client based application can execute to monitor a coffee bean or coffee bean blend roast. The client based application may monitor the temperature over time of the roast, add data indicating certain events during the roast, such as first cracking, store the roast data and upload the roast data to the network-based application. The client based application can also receive, store and upload other data, such as coffee bean data, user data, and other data, all of which can be uploaded to the network-based application.

The network service can be implemented as a network based application that provides interfaces, for example in the form of network content pages such as web pages. The interfaces allow the user to manage the user's coffee bean and roast data, track inventory and requests for user coffee beans, add information such as cupping notes to a particular roast, process data for blends of coffee bean roasts, and perform other processing and analysis.

The present technology may provide a networked community for sharing coffee bean data and coffee bean roasting data. A user may store data regarding the user's coffee beans and coffee bean roasts. The user may configure all or a portion of her saved data to be shared within a community of other coffee roasters. The user may also access other coffee bean and coffee bean roast data shared by other users in the community. The shared data may be used to generate roast profiles, predict roast results, or suggest roasts to a user.

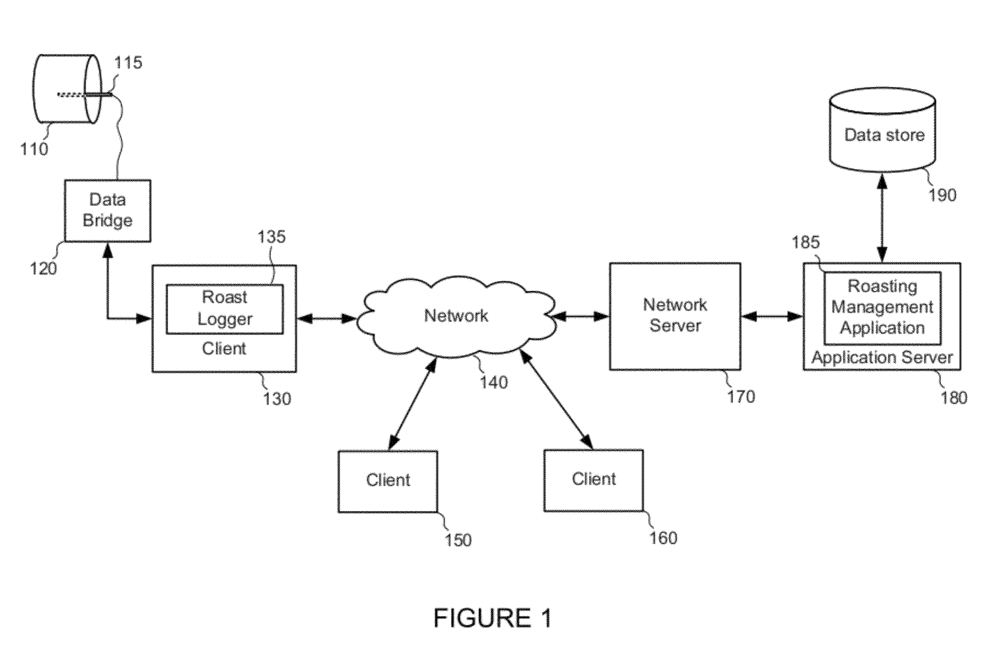

FIG. 1 is a block diagram of an exemplary system for managing coffee bean roast data. The system of FIG. 1 includes a coffee roaster 110, data bridge 120, client 130, network 140, clients 150 and 160, web server 170, application server 180 and data store 190.

Client 135 includes roast logger application 135 and communicates with data bridge 120 and network 140. Roast logger application 135 may log roast data acquired from data bridge 120. A user having an account with roast management application 185 may access his or her account using roast logger application 135. For example, a user may upload bean and roast data, access roast profile data, and retrieve information regarding what roasts should be performed based on requests received from user customers.

Data bridge 120 may receive temperature readings from thermo-couple or thermometer 115. Roast logger application 135 may receive roast data, such as temperature values, from the data bridge periodically, for example every second, retrieve temperature readings based on another event, or by receiving temperature readings broadcast by the data bridge. Roaster 110 may be used to roast coffee beans, either a single type of bean at a time or a blend of coffee beans, and may be configured to receive thermocouple 115. Thermocouple 115 may detect the temperature of the roaster and provide temperature data to data bridge 120. Roaster 110 may also include an afterburner that burns particulates generated by the roaster during roasting. The temperature and/or other operation data for the afterburner may be detected by a thermocouple or other monitoring device and provided to data bridge 120 or directly to roast logger application 135 on client 135.

Roast management application 185 may be executed on application server 180 to provide a network service for managing roast related data, including coffee bean data, coffee bean roast data, account data, sharing of data, and other data. Application server may communicate with data store 190 and network server 170 and be implemented as a computing device, a virtual machine, or some other entity. Network server 170 may communicate with application server 180 and network 140, and may receive requests from network 140. The requests may be processed by network server 170 or provided to roast management application 185 on application server 180. Roast management application 185 may process requests from network server 170 and provide a response, such as for example data to provide through a network browser application, for network server 170 to transmit to the requesting client.

Data store 190 may communicate with application 180, such as for example by processing queries for data and storing data related to coffee beans, coffee bean roastings, user account data, and other data. Data store 190 may be implemented on a different machine than application server 180 or on application server 180.

Network 140 may facilitate communication between clients 130, 150, and 160, network server 170, and application server 180. Network 140 may be implemented as a private network, public network, a local area network, wide area network, the Internet, an intranet, or a combination of these.

Roast management application 185 may provide an interface for managing bean data, coffee bean roasting, and other data within the scope of the technology. The interface may be provided through an application on a client device. For example, when network 140 is implemented as the Internet, the interface provide by roast management application may be web page content provide to an internet browser application on client 160.

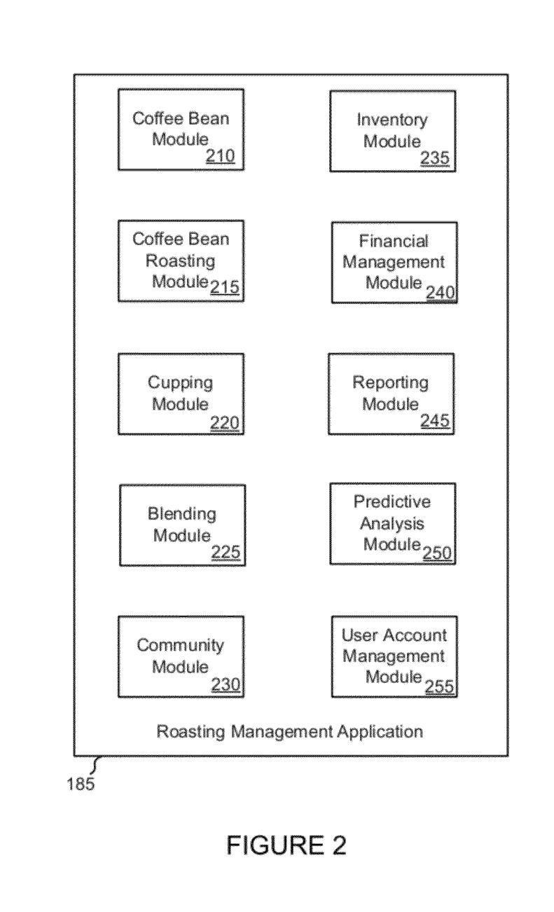

FIG. 2 is a block diagram of an exemplary roast management application 185. The exemplary roast management application 185 of FIG. 2 provides more detail for roast management application 185 of FIG. 1.

Roast management application 185 of FIG. 2 may include programs or modules for providing the functionality of the present technology. The modules may include beans module 210, roasting module 215, cupping module 220, blending module 225, community module 230, inventory module 235, order management module 240, reporting module 245, predictive analysis 250, and user account management module 255.

Coffee bean module 210 may manage coffee bean data. Coffee bean data may include data such as bean name, type, origin, species, processing method, date of purchase, inventory (e.g., quantity), mass before roasting, purchase price, lot numb, average shrinkage, and other data. Other bean data may include data relevant to the bean or added by the user. Coffee bean module 210 may receive bean data from a roast logger application, from a user via a network browser application, or in some other manner, and store the bean data in association with a user account.

Coffee bean roasting module 215 may manage coffee bean roasting data. When roast data is received, the roast data module may store the received roast data in association with a user's account (i.e., for the bean that was roasted). The roast data may include a string of temperature readings and corresponding time readings, the start mass of the roast, a roast identifier (for example a global unique identifier), the date of the roast, the operator of the roaster (user's name, since roasters like know who roasted what), and identification of the bean that was roasted.

Cupping module 220 may manage cupping data for a particular coffee bean roast. Cupping is the process by which roasted beans are brewed, tasted and evaluated for quality. The process of cupping may include taking a sample of the roasted beans, recording the smell of the roasted beans, grinding the beans and noting the smell of the grinded roasted beans, adding hot water and tasting the resulting roasted coffee bean brew, and waiting a period of time and tasting the brew again. There may be several different steps that can be performed in the course of cupping, based on the preference of the user. Data for each step of cupping can be received and managed by cupping module 215. When roast data is received, the roast data module may store the received roast data in association with a user's account (i.e., for the bean that was roasted).

Blending module 225 may manage data associated with blends of coffee beans. For example, bending module 225 may manage user updates to the proportioned ingredients for a blend, calculating what quantities of specific ingredients are required for a particular finished product of roasted coffee beans for a blend, and other blend data.

Community module 230 may manage sharing of data associated with the present technology, such as coffee bean data, coffee bean roast data, blend and cupping data, and other data. Community module 230 may also manage permissions on access to a user's data, for example whether a user wishes to share their coffee data (the collective data associated with a user account), and which members of a community (i.e., other users) may view specific portions of the user's bean data, roast data, and other data.

Inventory module 235 may process the inventory of coffee beans and blends based on an initial quantity and updates provided via roast log data and user entries. Inventory module 235 may initiate an alert based on whether the quantity of a coffee bean or blend of coffee beans is less than a threshold.

Order management module 240 may automatically manage and provide pricing information and estimates for roasted coffee beans. For example, order management module 240 may provide the quantity of green (unroasted) coffee beans required to generate a profit specified by a user. Order management module 240 may also receive and process orders for customers of a user having an account with the coffee roasting management service. For example, a user may have three customers that may place orders with the user. The orders may be placed by allowing the customers to provide input through an interface provided by roast management application 185. The orders may include a one time order or a recurring order, such as for example an order of blend to provide on a weekly basis. Order management module 240 may aggregate data for similar coffee bean roasts and provide it to the user. The information may be provided to the user when the user logs into her account with roast management application 185 or when the user executes roast logger application 135, thereby initiating roast logger application 135 to retrieve order information from roast management application 185.

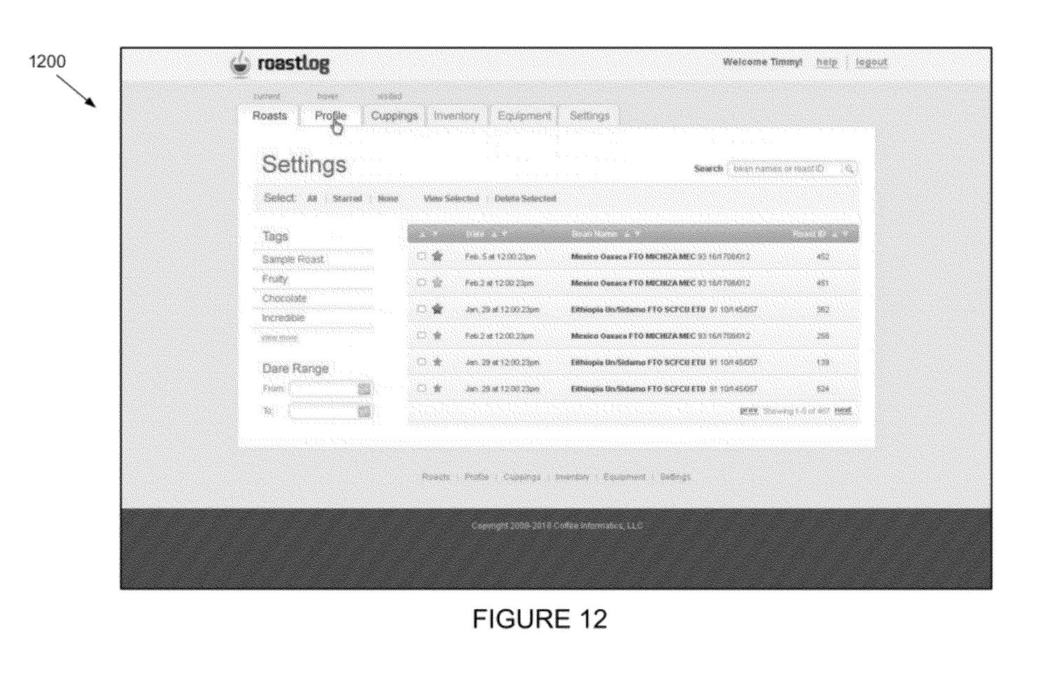

Reporting module 245 may provide reports requested by a user regarding the user's coffee bean data, coffee bean roast data, cupping data, inventory, and so forth. Reporting module 245 may provide the requested data via one or more interfaces provided through a network browser, such as for example the interfaces illustrated in FIGS. 12-14.

Predictive analysis module may analyze a user's current coffee data (“coffee data” including at least the user's coffee bean data, coffee bean roast data, cupping data, blending data, inventor data, and user account data) to suggest or predict roast profiles for the user, coffee beans the user may be interested in, a cupping template for a bean or blend, or other information.

User account management module 255 may create a user account, associate received coffee data with the user account, manage user permissions, alerts associated with coffee data, and perform other administrative functions associated with a user's account with the service provided by roast management application 185.

It is intended that additional or fewer modules may be implemented as part of roast management application 185, including combination or separation of the modules discussed with reference to FIG. 2. The modules listed are examples of one implementation of a roast management application 185, and are not intended to limit the scope of application 185 or the functionality of the service provided by the application 185.

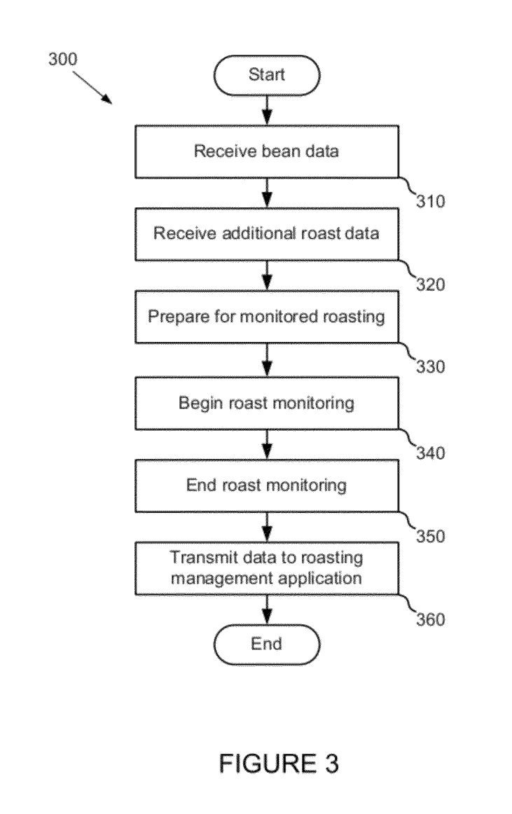

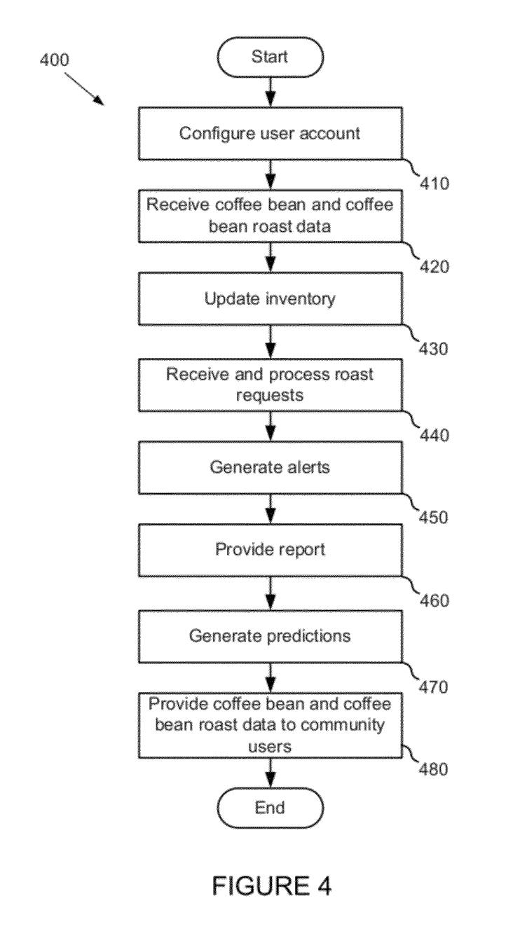

FIGS. 3-10 illustrate the operation of the system in FIG. 1. In particular, the discussion with respect to FIG. 3 relates to an example of operation for client 130 with roast logger application 135. The discussion with respect to FIGS. 4-10 relates to an example of operation for roast management application 185 on application server 180, as well as other devices that may communicate with application 185.

FIG. 3 is a flow chart of an exemplary method for logging roast data and may be performed by roast logger application 135 on client 130. Bean data is received at step 310. The bean data may be received by client 150 from input received from a user at client 150, from data accessible to and provided by roast management application 185, or some other source. The bean data may include the bean type, origin, date acquired or purchased, mass, quantity, and so forth. The received bean data may include data associated with one or more orders managed by an order management module of roasting management application 185. The received data may include the user modifying data received from another source, such as application 185. The received data may also include roasting environment data such as ambient temperature, humidity and amount of gas flow into the roaster.

Roast data may be received at step 320. The roast day may include an identifier for the roaster used to perform a roast, the degree of roast (e.g., light, medium, dark), the planned time of the roast, the planned profile for the roast, and other roast data. The roast data may be received by roast logger 135 via user input through client device 130, from data received by roast management application 185, or in some other manner.

Preparations are made for the monitored roasting at step 330. The preparation may include pre-heating the roaster 110, placing the thermocouple or thermometer 115 in an appropriate position within the roasting chamber, and placing beans in the hopper of the roaster 110. Additional preparations may include initializing data bridge 120 and a new roast profile, including generation of a roast identifier, at roast logger 135

Roast monitoring begins at step 330. Monitoring a roast may include monitoring the temperature of one or more areas or components of a roaster, or a device working in conjunction with the roaster. For example, the temperature may be monitored for a chamber for roasting coffee beans and an afterburner that burns particulates generated by the roaster. The temperature of the monitored portions may be provided to data bridge 120 via one or more data thermocouples, thermometers, or other devices that communicate a temperature data. Roast logger application 135 may receive the temperature data from data bridge 120, for example by sampling data values from the data bridge periodically, such as for example every second, five seconds, or some other time period. The sampled temperature data may include data for a bean roasting chamber or an afterburner. The temperature readings and a corresponding time stamp (time stamp generated by data bridge 120 or roast logger application 135, per user preference) are stored by roast logger 135 during monitoring of the roast. Temperature data stored by roast logger 135 may be used to at least to generate roast data, provide evidence regarding burning of particulate matter, for example to satisfy environmental regulations or requirements, and for other purposes.

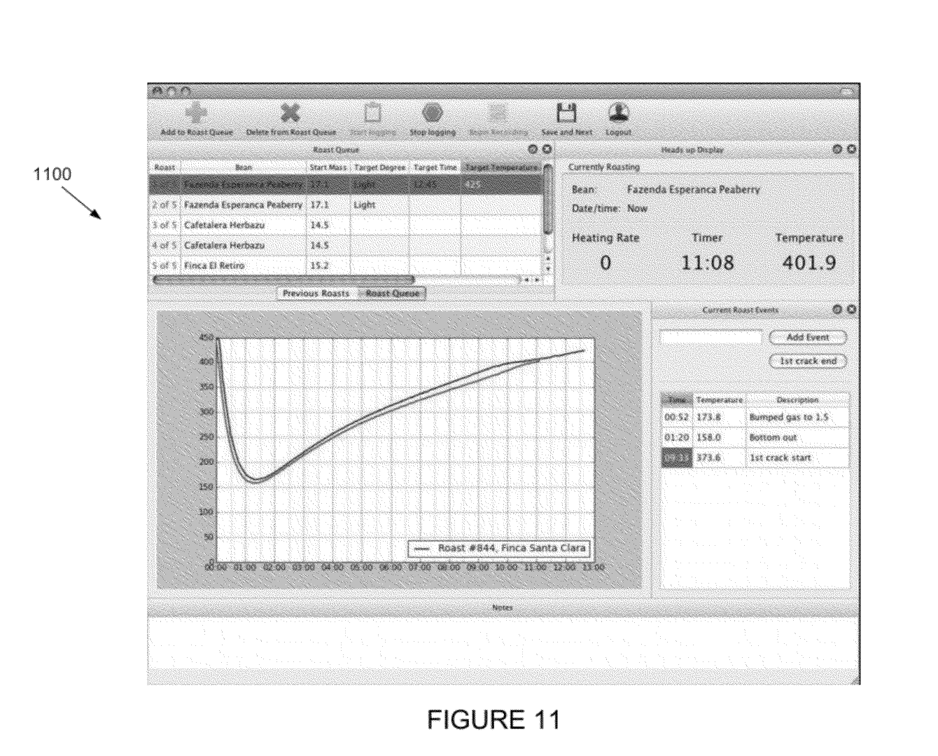

Roast monitoring ends at step 350. Monitoring may end at a specific time, when a specific temperature is detected by the thermocouple 115, when a user manually stops the monitoring, or based on some other event. After a roast has been monitored, the coffee bean roast data and any coffee bean data is transmitted to roast management application 185 at step 190. An example of an interface provide by roast logger application 135 is provided in FIG. 11 and discussed in more detail below.

FIG. 4 is a flow chart of an exemplary method for managing roast data. The method of FIG. 4 may be performed by roast management application 185. First, a user account is configured at step 410. A user account may be configured by providing user identification information, a username and password, communication preferences, and other information.

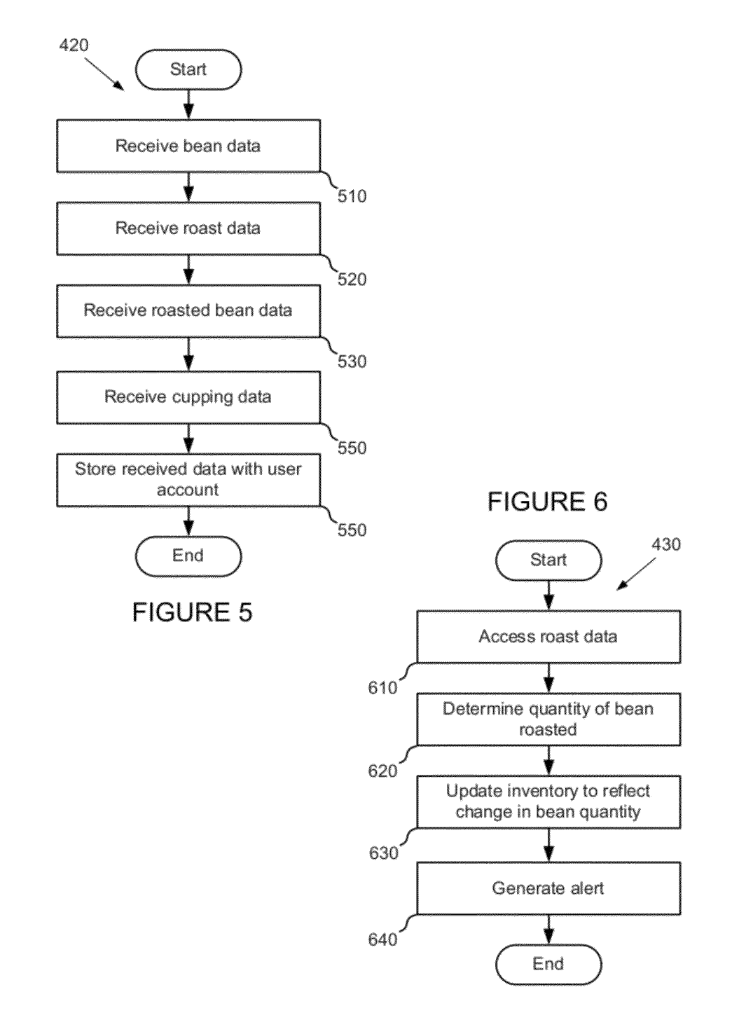

Coffee bean and coffee bean roast data is received at step 420. The data may be received by a user, such as for example through an interface provided by a network browser on a client 150 or 160. The data may also be provided from roast logger 135 via network 140. The received coffee bean and coffee bean roast data may be stored and linked to the user's account such that modules of roast management application 185 may access and process the data to provide the user with information such as inventory updates, alerts, and other information. Receiving coffee bean and coffee bean roast data is discussed in more detail below with respect to FIG. 5.

Inventory may be updated at step 430. Inventory updates may be based on the original quantity of the coffee beans or blends and data regarding changes to the beans. Updating coffee bean inventory is discussed in more detail below with respect to FIG. 6.

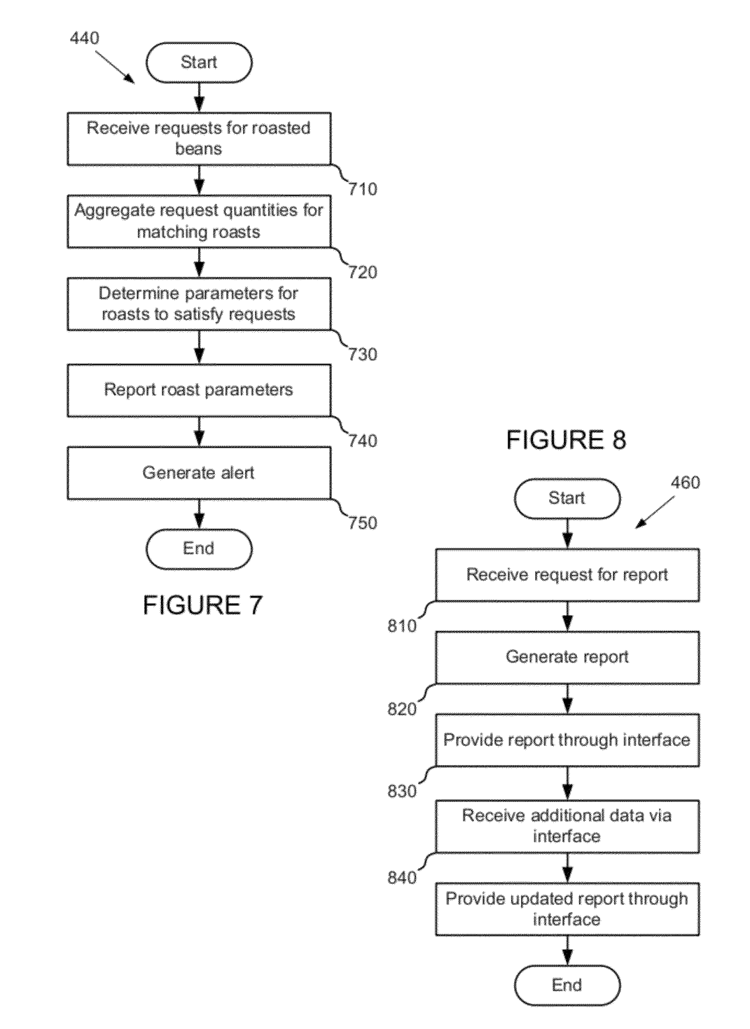

Roast requests may be received and processed at step 440. The user may provide roasted coffee beans to friends, customers, wholesalers, or other entities. For this reason, the user may with to track orders and requests for roasted coffee beans and coffee bean blends. Processing a roast request is discussed below with respect to FIG. 7.

Alerts may be generated at step 450. The alerts may indicate that an inventor is low, that shared data is available for a particular coffee bean or coffee bean roast, or other event has occurred. A user may configure an alert to occur based on the event, for example to trigger an alert if a tracked inventory for a particular coffee bean drops below a specified amount of ten pounds. Each alert may also be configured in how it is communicated to the user, such as for example by text message, email, visual notification on a home page provided for the user by the roast management application, a combination of these, or some other manner. Alerts may be configured and handled by reporting module 245, by a portion of other modules (e.g., bean alerts provided by bean module 210), or a dedicated alert module (not illustrated in FIGS. 1-2).

A report may be provided at step 460. A report may be provided by reporting module 245 and may include coffee data provided through an interface, such as for example via a web page provided to clients 150 or 160. The report may include coffee bean data, coffee bean roast data, cupping data, inventory data, predicted coffee data, blend data, shared coffee data, and other data provided through an interface. The report may also include any coffee data associated with a user, or accessible through a community of users which shared coffee data, that satisfies a query submitted for a user. Examples of interfaces which may be provided by reporting module 245 are provide in FIGS. 11-14 and discussed in more detail below.

FIG. 5 is a flow chart of an exemplary method for receiving bean and roast data. The method of FIG. 5 may be performed at least in part by modules 210, 215, 220, and 225 and provides more detail for step 420 of the method of FIG. 4. Coffee bean data is received at step 510. The coffee bean data may include type, origin, condition, species, data acquired, date harvested, and other data. Roast data may be received at step 520. Roast data may include temperature and timing data for the roast, identifier for the roaster that performed the roast, level of roasting (light, medium, dark), and other data.

Receiving coffee bean and coffee bean roast data may also include receiving user input to the data. For example, a user may indicate a favorite roast or bean, provide notes on the bean and roast, or other information.

Receiving coffee bean data and coffee bean roast data may also include receiving blend data, for example an identifier for a blend and the percentages of each bean that comprise the blend.

Roasted bean data may be received at step 520. Roasted bean data may provide the user with an opportunity to add data for a roasted bean without performing the roasting herself.

Cupping data may be received at step 550. The cupping data may include the cupper's notes regarding the smell of the bean, taste of the roasted bean, taste of the bean with hot water after different periods of time, and other data.

The received data may be stored by roasting management application 185 at step 550. The data may be stored in association with the user's account with the roast service provided by application 185 and may be accessed and provided via one or more interfaces upon request by the user, or by another user if the associated user allows sharing of the data.

FIG. 6 is a flow chart of an exemplary method for managing bean inventory. The method of FIG. 6 may be performed at least in part by inventory module 235 and provides more detail for step 430 of the method of FIG. 4. Roast data may be accessed at step 430. A determination may be made from the roast data regarding the quantity of coffee beans used in a roast at step 620. The data received at step 610 may also be provided by a user to indicate an addition or subtraction to the quantity of a particular coffee bean in inventory.

Once the change in coffee beans is known, the inventory level for the coffee bean is determined at step 630. An alert may be generated if the updated inventory level falls below a specified threshold for that coffee bean or coffee bean blend.

FIG. 7 is a flow chart of an exemplary method for processing roast requests. The method of FIG. 7 may be performed at least in part by any of inventory module 235, order management module 240, or a request processing module (not illustrated) and provides more detail for step 460 of the method of FIG. 4.

One or more requests are received for roasted coffee beans at step 710. The request may be a recurring request, a custom request, or some other request. The request may be an amount of one or more roasted coffee beans, roasted blend of coffee beans, or a combination of both. The request quantities are aggregated for matching roasts at step 720. Hence, if two requests are received for ten pounds of roasted coffee bean A, the requests would be aggregated to indicate twenty pounds of roasted coffee bean A is requested.

The parameters for the roasts to satisfy the requests are determined at step 730. When a coffee bean is roasted, the mass of the bean decreases. Hence, if nine pounds of coffee bean A is required, and coffee bean A loses ten percent of it's mass during the roasting required, then ten pounds of green coffee bean A may be required to meet the roast requests for coffee bean A. Other parameters may include the time required to meet all the roasting requests, the particular roaster, and other parameters.

The determined roast parameters are reported in step 740 and any corresponding alerts are generated and transmitted at step 750. For example, an alert may be generated if a roasting parameter indicates that not enough coffee bean supply is available to meet a request, or that a request may require over a certain period of time to fulfill.

FIG. 8 is a flow chart of an exemplary method for generating a report. The method of FIG. 8 may be performed at least in part by report module 245 and provides more detail for step 460 of the method of FIG. 4.

A request for a report may be received by roast management application 180 at step 810. The request may be in the form of a query for particular coffee data, a request for an interface page, or some other request for reported data.

The report may be generated at step 820. Generating the report may include executing reporting module 245 to provide an interface as a web page, querying data in data store 190 by reporting module 245 or some other module, or otherwise retrieving data for the requesting user. The resulting report may be provided through an interface at step 830. In some embodiments, the report may be provided in some other form, such as an SMS message, MMS message, email, or some other format per the user's preference.

Additional data may be received through the interface at step 840. The additional dada may include notes to the reported data, such as cupping notes, or other user input. The report may then be updated with the user updates, and the updated report is provided to the user at step 840. Examples of reports for providing bean data, roast data, and other data are described in more detail with respect to FIGS. 11-14.

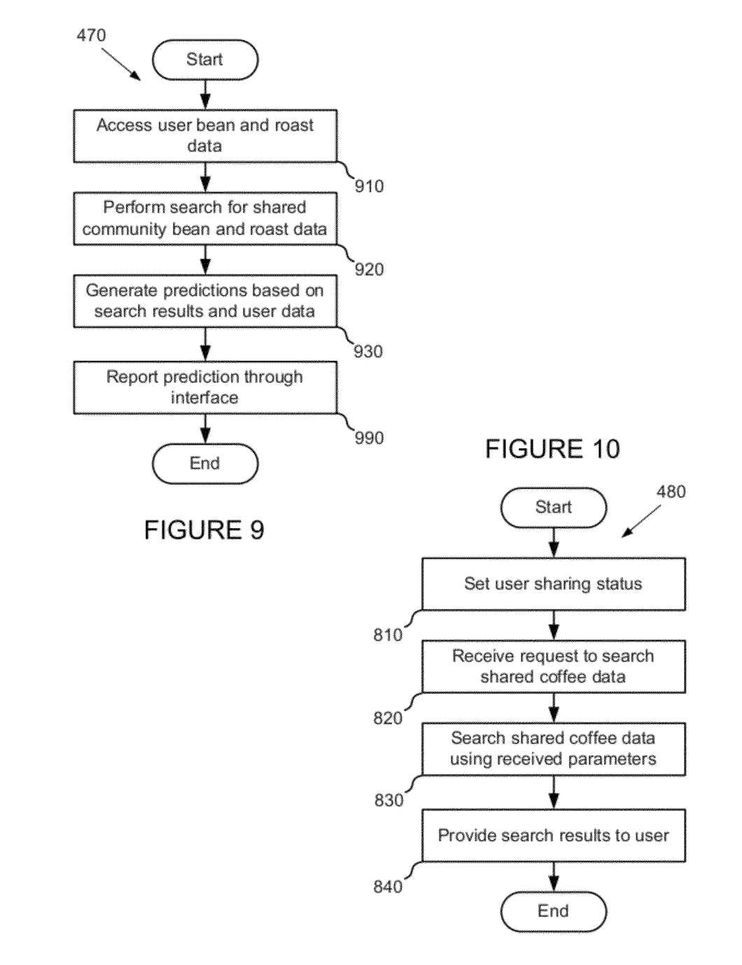

FIG. 9 is a flow chart of an exemplary method for generating a roast prediction. The method of FIG. 9 may be performed at least in part by predictive analysis module 250 and provides more detail for step 470 of the method of FIG. 4. User coffee bean data, coffee bean roast data, and other user coffee data may be accessed at step 910.

A search may be performed for shared coffee data that corresponds to one or more files of the user's coffee data at step 920. For example, if a user has a particular coffee bean and no roast data for the coffee bean, the predictive analysis may search for coffee bean roast profiles performed by other users in the community for the coffee bean. If the user has indicated a preference or favorite bean from a particular area, a search may be made for other beans with the same origin.

Predictions and suggestions may be generated based on the search results and user coffee data at step 930. The generated search results may be reported to the user through an interface such as a web site at step 990.

FIG. 10 is a flow chart of an exemplary method for accessing shared roast data. The method of FIG. 10 may be performed at least in part by user account management module 210 or a sharing module (not illustrated) and provides more detail for step 480 of the method of FIG. 4.

A user sharing status may be set at step 810. The sharing status may be stored with the user's account settings and may indicate whether the user would like all or a portion of her coffee data shared with other users of the service, whether the user would like to have suggestions automatically provided, or based on request, based on other users' coffee data, and other sharing preferences.

A request to search the user's coffee data may be received at step 820. The request may be processed if the user's sharing preference indicates that the user has provided permission for the requested user coffee data to be shared. If the user has not indicated that the requested coffee data can be shared, the user's coffee data will not be provided in response to a coffee data request by another user.

If the user has indicated that the requested coffee data can be shared, the user's coffee data can be searched in response to the request for coffee data at step 830. The search may include parameters for the data to be shared, such as a type of coffee bean, cupping notes for a particular blend, and so forth. The parameters are used to query data store 190 by roast management application 185. In some embodiments, the query with the parameters is sent to data store 190 without confirming which users allow their coffee data to be searched. Data store 190 will process the query by searching only the user coffee data for which sharing has been permitted by the corresponding user, and send a response with any results of the query. Results of the search are provided to the requesting user at step 840.

FIG. 11 is an exemplary interface 1100 for managing roast logging. The interface of FIG. 11 may be provided by roast logger 135. Interface 1100 provides data associated with a roast that is in progress or previously completed. The information may include a roast queue with roast identifier, bean description, start mass, roasting degree information, target time, and target temperature. Roast queue information may also be provided for previous roasts. Graphical data for a roast may be provided, for example the temperature readings for a roast over a period of time. For a current roast, the interface may indicate the bean, date and time, heating rate, timer information and current temperature. Roasting events may be added to the roast data via interface 1100 as the bean is roasting, such as for example temperature notes, first crack of the beans, and other events.

FIG. 12 is an exemplary interface 1200 for managing coffee bean roast data. Interface 1200 may be provided by reporting module 245 in cooperation with coffee bean roasting module 215. Interface 1200 provides data for one or more roasts, including rating information, date and time of roast, identifications of roasted beans, and identifier for the roast. The interface of FIG. 12 allows a user to search coffee data to provide desired coffee bean or coffee bean roast data through the interface 1200.

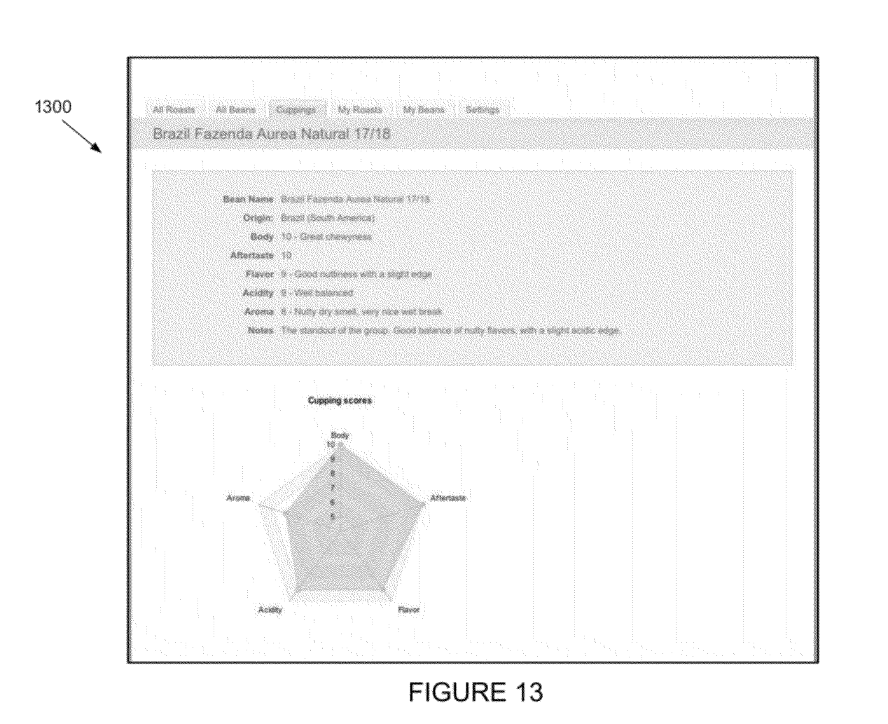

FIG. 13 is an exemplary interface 1300 for managing cupping data. Interface 1300 may allow a user to enter data into a cupping template for a particular coffee bean or blend. The template may include the coffee bean name, origin, body rating, aftertaste rating, flavor rating, acidity rating, aroma rating, and notes. Each rating may be associated with predefined context (e.g., body rating of 10 corresponds to great chewiness) or a user may provide context comments for the particular rating. A user may also provide a custom set of fields for providing cupping data. The cupping data may be graphically represented within interface 1300, for example using rating data provided by the user.

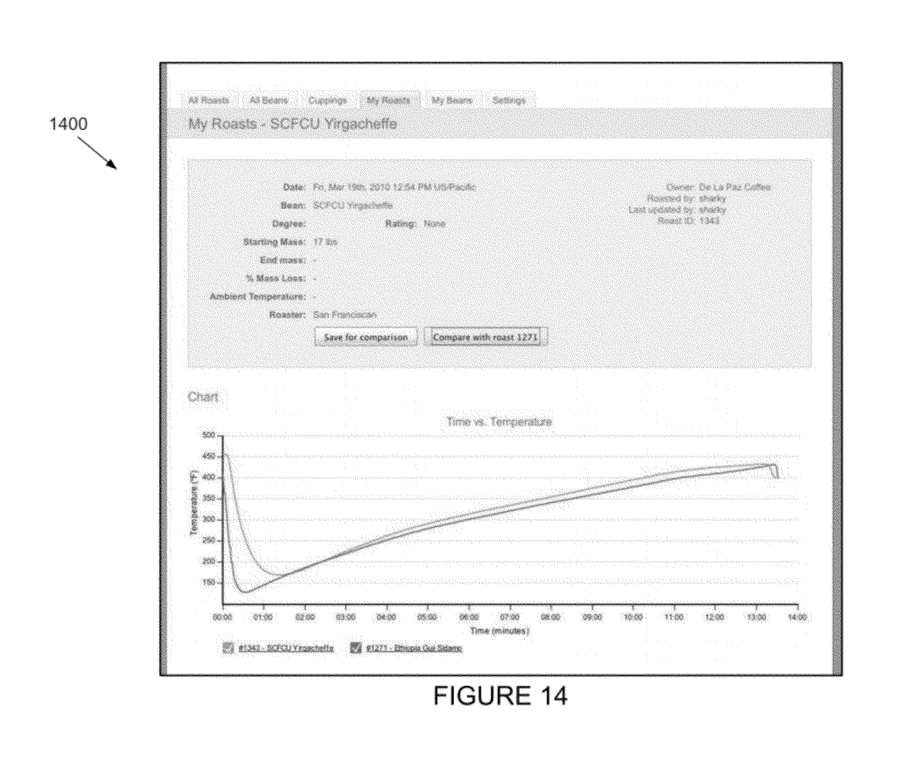

FIG. 14 is an exemplary interface 1400 for managing coffee bean roast data. Interface 1400 provides data for a first roast having an identifier of 1343 and a second roast having an identifier of 1271. Roasting data of time versus temperature is provided for each roast, superimposed on a chart within interface 1400. The roasts may be for a similar bean, the same bean, a different bean; any other roast can be compared within a single chart within interface 1400. By superimposing the roast data as indicated in interface 1400, a user can view the different roasting profile for the roasts and make notes accordingly. For example, the user may indicate that roast 1343, which had a higher temperature at one minute than roast 1271, produced roasted coffee beans which had a better taste or a different body than those of roast 1271.

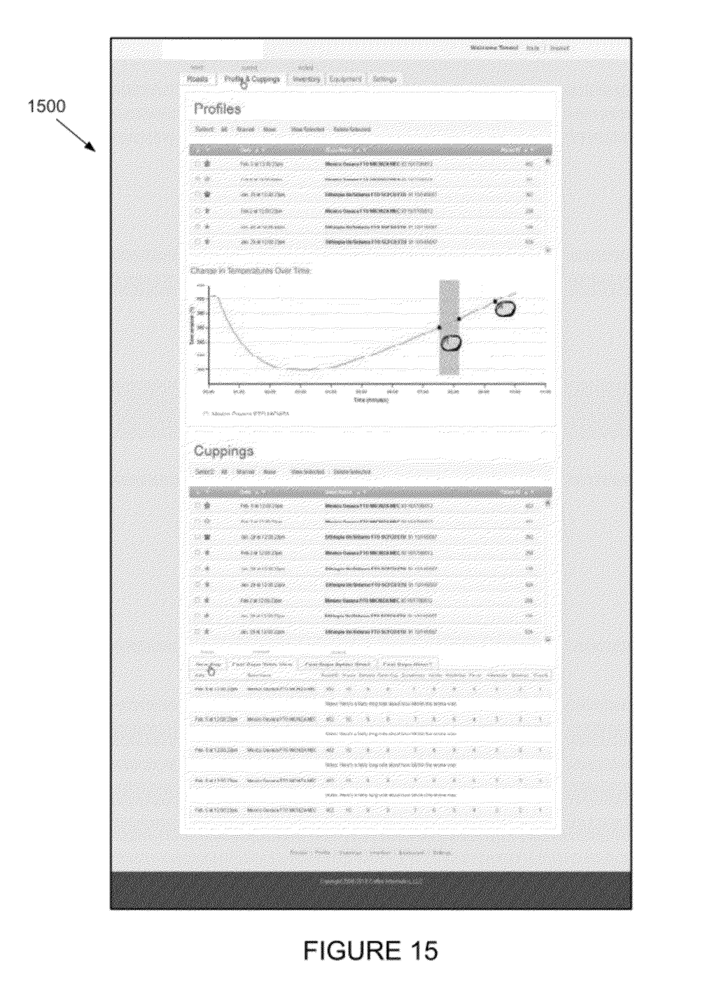

FIG. 15 is an exemplary interface 1500 for managing a user roast profile. Interface 1500 (which may be provided by reporting module 245) may provide a list of roasts to choose from and information for the selected roast. For the selected roast, the interface 1500 may provide roasting data of temperature over time for the roast, data points at the roast at which a user may provide notations or indicate are of interest, cupping data for the particular roast, and other data.

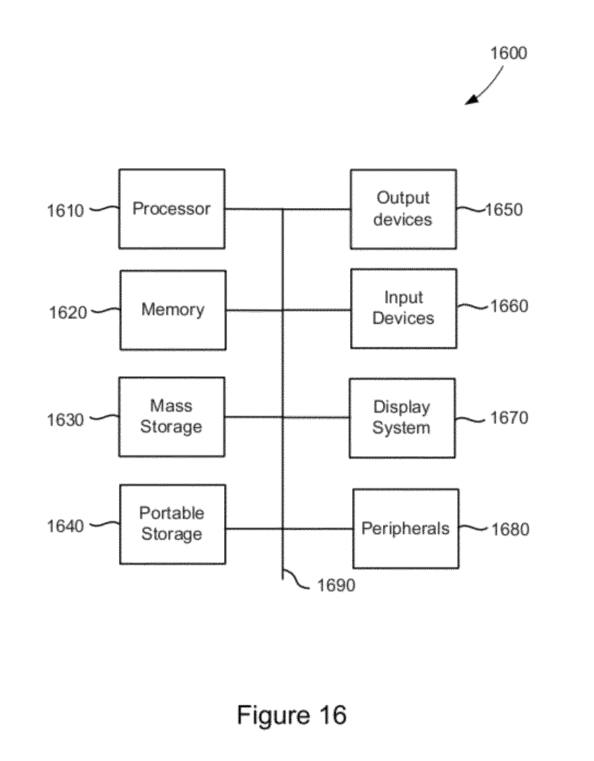

FIG. 16 illustrates an exemplary computing system 1600 that may be used to implement an embodiment of the present technology. System 1600 of FIG. 16 may be implemented in the contexts of the likes of clients 130, 150 and 160, network server 170, application server 180, and data store 190. The computing system 1600 of FIG. 16 includes one or more processors 1610 and memory 1620. Main memory 1620 stores, in part, instructions and data for execution by processor 1610. Main memory 1620 can store the executable code when in operation. The system 1600 of FIG. 16 further includes a mass storage device 1630, portable storage medium drive(s) 1640, output devices 1650, user input devices 1660, a graphics display 1670, and peripheral devices 1680.

The components shown in FIG. 16 are depicted as being connected via a single bus 1690. However, the components may be connected through one or more data transport means. For example, processor unit 1610 and main memory 1610 may be connected via a local microprocessor bus, and the mass storage device 1630, peripheral device(s) 1680, portable storage device 1640, and display system 1670 may be connected via one or more input/output (I/O) buses.

Mass storage device 1630, which may be implemented with a magnetic disk drive or an optical disk drive, is a non-volatile storage device for storing data and instructions for use by processor unit 1610. Mass storage device 1630 can store the system software for implementing embodiments of the present invention for purposes of loading that software into main memory 1610.

Portable storage device 1640 operates in conjunction with a portable non-volatile storage medium, such as a floppy disk, compact disk or Digital video disc, to input and output data and code to and from the computer system 1600 of FIG. 16. The system software for implementing embodiments of the present invention may be stored on such a portable medium and input to the computer system 1600 via the portable storage device 1640.

Input devices 1660 provide a portion of a user interface. Input devices 1660 may include an alpha-numeric keypad, such as a keyboard, for inputting alpha-numeric and other information, or a pointing device, such as a mouse, a trackball, stylus, or cursor direction keys. Additionally, the system 1600 as shown in FIG. 16 includes output devices 1650. Examples of suitable output devices include speakers, printers, network interfaces, and monitors.

Display system 1670 may include a liquid crystal display (LCD) or other suitable display device. Display system 1670 receives textual and graphical information, and processes the information for output to the display device.

Peripherals 1680 may include any type of computer support device to add additional functionality to the computer system. For example, peripheral device(s) 1680 may include a modem or a router.

The components contained in the computer system 1600 of FIG. 16 are those typically found in computer systems that may be suitable for use with embodiments of the present invention and are intended to represent a broad category of such computer components that are well known in the art. Thus, the computer system 1600 of FIG. 16 can be a personal computer, hand held computing device, telephone, mobile computing device, workstation, server, minicomputer, mainframe computer, or any other computing device. The computer can also include different bus configurations, networked platforms, multi-processor platforms, etc. Various operating systems can be used including Unix, Linux, Windows, Macintosh OS, Palm OS, and other suitable operating systems.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claims appended hereto.

The present technology is described above with reference to exemplary embodiments. It will be apparent to those skilled in the art that various modifications may be made and other embodiments can be used without departing from the broader scope of the present technology. Therefore, these and other variations upon the exemplary embodiments are intended to be covered by the present technology.

1. A method for managing a coffee roasting, comprising:
receiving coffee bean roast data from a remote client device;
associating the coffee bean roast data and the coffee bean data with a user account with a roast management service; and
reporting the coffee bean roast data and the coffee bean data by a server through an interface provided over a network.

2. The method of claim 1, the coffee bean roast data including temperature data.

3. The method of claim 1, the coffee bean roast data including afterburner data.

4. The method of claim 1, further comprising receiving coffee bean data;

5. The method of claim 4, the coffee bean data including type and quantity.

6. The method of claim 4, the coffee bean data including data for a blend of coffee beans.

7. The method of claim 4, further comprising automatically determining an inventory update based on the coffee bean data and coffee bean roast data.

8. The method of claim 1, further comprising generating an alert based on the determined inventory update.

9. The method of claim 1, wherein reporting includes providing a report through an interface provided to a network browser application.

10. The method of claim 1, further comprising receiving cupping data for the coffee bean roast data.

11. The method of claim 1, further comprising:
accessing a shared collection of coffee bean roast data; and
generating a prediction for a first coffee bean roast based on the accessed collection of coffee bean roast data.

12. The method of claim 1, further comprising:
receiving a request by a first user to access shared coffee bean roast data; and
accessing shared coffee bean roast data.

13. The method of claim 1, wherein reporting the coffee bean roasting data includes superimposing a first set of coffee bean roasting data associated with a first roast and a second set of coffee bean roasting data associated with a second roast on an interface.

14. A method for storing roast data, comprising:
receiving a series of temperature data points by a computing device, the temperature data points associated with a roast of one or more coffee beans;
storing the temperature data points and timestamps associated with each temperature data point by the computing device; and
transmitting the temperature data points and timestamps to a remote network application, the temperature data points and timestamps to be stored in association with a roast management account associated with a user.

15. A computer readable storage medium having embodied thereon a program, the program being executable by a processor to perform a method for authoring a protocol to coach a user, the method comprising:
receiving coffee bean roast data from a remote client device;
associating the coffee bean roast data and the coffee bean data with a user account with a roast management service; and
reporting the coffee bean roast data and the coffee bean data by a server through an interface provided over a network.
